(19) United States
(12) Patent Application Publication
(10) Pub. No.: US 2024/0262183 A1
(43) Pub. Date: Aug. 8, 2024

(54) FUEL TANK

(71) Applicant: YACHIYO INDUSTRY CO., LTD., Saitama (JP)

(72) Inventors: Kazunari NAKAYA, Tochigi (JP); Masaki MORISAKI, Tochigi (JP); Kazuyoshi MOROOKA, Tochigi (JP)

(21) Appl. No.: 18/290,911

(22) PCT Filed: Jul. 11, 2022
(86) PCT No.: PCT/JP2022/027272

§ 371 Date: Jan. 22, 2024

(30) Foreign Application Priority Data
Jul. 26, 2021 (JP) 2021-121190

(51) Int. Cl. B60K 15/03

(52) U.S. Cl. CPC B60K 15/03177; B60K 2015/03046

(57) ABSTRACT

A fuel tank includes an internal component having a head portion, a neck portion, and a shoulder portion, in which the internal component is fixed on a tank main body by shaping a parison to the head portion, the neck portion and the shoulder portion during molding of the tank main body. Here, in the fuel tank, the head portion has a rotation-stopping shape. The rotation-stopping shape is preferably an elliptical shape or an oval shape. Further, the rotation-stopping shape is preferably a broad bean shape.

### CROSS-REFERENCE TO RELATED APPLICATION

This application is a U.S. National Stage Application under 35 U.S.C. § 371 of International Patent Application No. PCT/JP2022/027272 filed on Jul. 11, 2022, which claims the benefit of priority to Japanese Patent Application No. 2021-121190 filed on Jul. 26, 2021, the disclosures of all of which are hereby incorporated by reference in their entireties.

### TECHNICAL FIELD

The present invention relates to a fuel tank.

### BACKGROUND ART

A recognized method exists for affixing components, such as valves, to blow-molded products, notably automobile fuel tanks, as internal components. For example, Patent Literature 1 describes a method for manufacturing a fuel tank that integrates an internal component, which includes a head portion, neck portion, and shoulder portion. Within this method of fuel tank fabrication, a parison is shaped along the neck portion by sending air from the exterior of the parison during the tank main body molding process, thus anchoring the internal component to the tank main body.

### CITATION LIST

### Patent Document

Patent Document 1: International Publication No. WO2018/225413

### SUMMARY OF INVENTION

### Technical Problem

In the invention according to Patent Document 1, the circular configuration of the head portion results in a tendency for the internal component to undergo rotational movement in the circumferential direction of the head portion subsequent to parison molding. Such rotation of the internal component after parison molding can pose a risk of instability within main the tank body, potentially compromising the strength thereof.

The present invention has been devised from such a perspective and aims to provide a fuel tank in which the internal component is difficult to rotate after parison molding.

### Solution to Problem

To achieve the aforementioned object, the present invention is a fuel tank which includes an internal component including a head portion, a neck portion, and a shoulder portion, the internal component being fixed on a tank main body by shaping a parison to the head portion, neck portion, and shoulder portion during molding of the tank main body molding. In the internal component, the head portion, the neck portion and the shoulder portion are respectively formed at both ends of a columnar torso portion. The shoulder portion is formed larger than the head portion and the neck portion. The head portion and the neck portion are embedded in opposing internal surfaces of the tank main body by wrapping the parison around the neck portion during molding of the internal component. Herein, the head portion has a rotation-stopping shape.

According to the present invention, since the head portion of the internal component has a rotation-stopping shape, it is possible to suppress the rotation of the internal component after parison molding.

Also, the rotation-stopping shape is preferably an elliptical shape, oval shape, or broad bean shape. Further, the head portion, the neck portion and the shoulder portion are similar, and the rotation-stopping shape is preferably a broad bean shape.

According to the present invention, the rotation of the internal component can be effectively and suitably suppressed.

### Advantageous Effects of Invention

According to the present invention, it aims to provide a fuel tank in which the internal component is difficult to rotate after parison molding.

### BRIEF DESCRIPTION OF DRAWINGS

FIG. 1 is a schematic cross-sectional view of a fuel tank according to the first embodiment of the present invention.

FIG. 2 is an external perspective view of an internal component according to the first embodiment of the present invention.

FIG. 3 is a front view of the internal component according to the first embodiment of the present invention.

FIG. 4 is a plan view of the internal component according to the first embodiment of the present invention.

FIG. 5 is a schematic longitudinal cross-sectional view of a fuel tank manufacturing device.

FIG. 6 is a diagram for explaining the transfer status of the parison around the end portion of the internal component during molding.

FIG. 7 is a diagram for explaining the transfer status of the parison around the end portion of the internal component during molding.

FIGS. 8A to 8C are each a diagram for explaining the method for manufacturing a fuel tank in the fuel tank manufacturing device, where FIG. 8A shows the injection process of the parison, FIG. 8B shows the insertion process of the internal component, and FIG. 8C shows the temporary setting process of the internal component.

FIGS. 9A to 9D are each a diagram for explaining the method for manufacturing a fuel tank in the fuel tank manufacturing device, where FIG. 9A shows the closing process of the mold, FIG. 9B shows the blow molding process, FIG. 9C shows the cooling process of the parison, and FIG. 9D shows the opening process of the mold.

FIG. 10 is an external perspective view of an internal component according to the second embodiment of the present invention.

FIG. 11 is a plan view of the internal component according to the second embodiment of the present invention.

### DESCRIPTION OF EMBODIMENTS

### First Embodiment

### <<Fuel Tank According to Embodiment>>

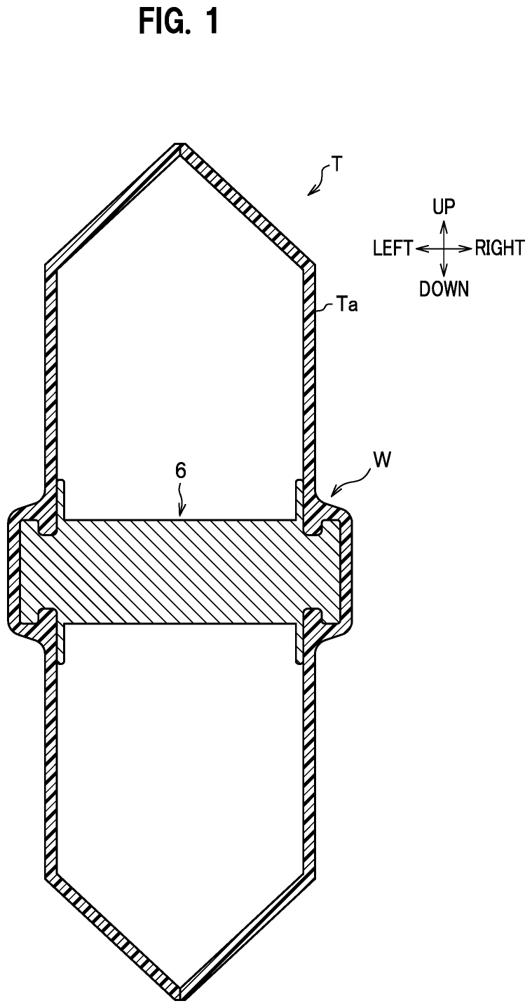

The fuel tank T shown in FIG. 1 is intended for installation in vehicles such as automobiles, motorcycles, and boats, and mainly includes a tank main body Ta and an internal component 6. As shown in FIG. 1, the present embodiment exemplifies a columnar reinforcement member as the internal component 6 to maintain the strength of the fuel tank T, but the internal component 6 can also be a valve or a wave damping plate. The terms “up and down” and “left and right” in the following description refer to the arrows in FIG. 1. Each direction is defined for the convenience of the description and does not limit the present invention. The left and right directions in FIG. 1 correspond to the opening and closing directions of a pair of molds used to manufacture the fuel tank T.

The tank main body Ta is a hollow container made of resin for storing fuels such as gasoline, and has a multilayered structure that includes a barrier layer, for example. The tank main body Ta is primarily made of thermoplastic resin such as polyethylene or high-density polyethylene. The tank main body Ta is formed, for instance, by blow molding.

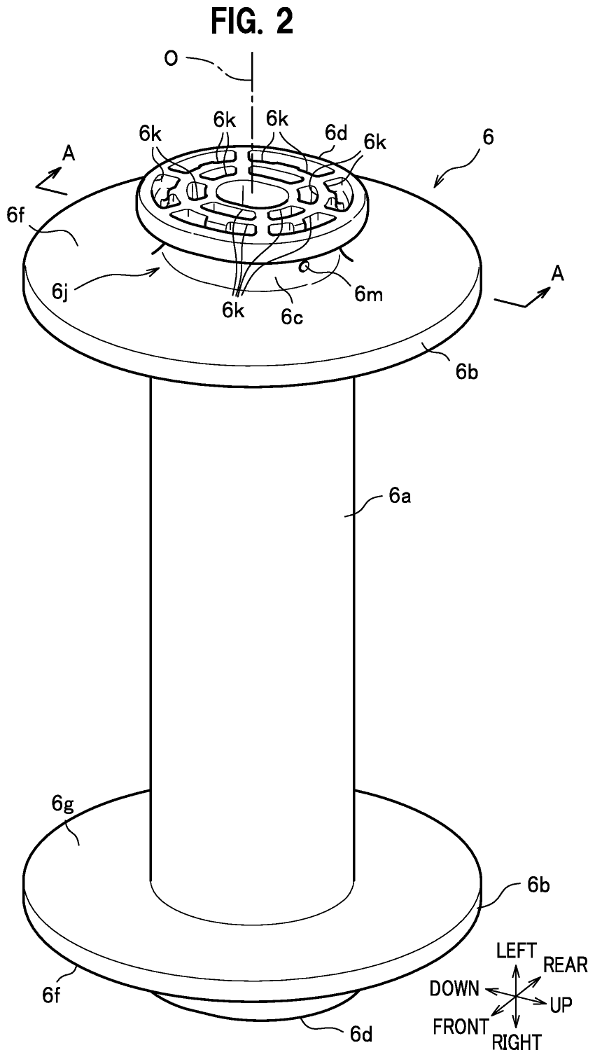

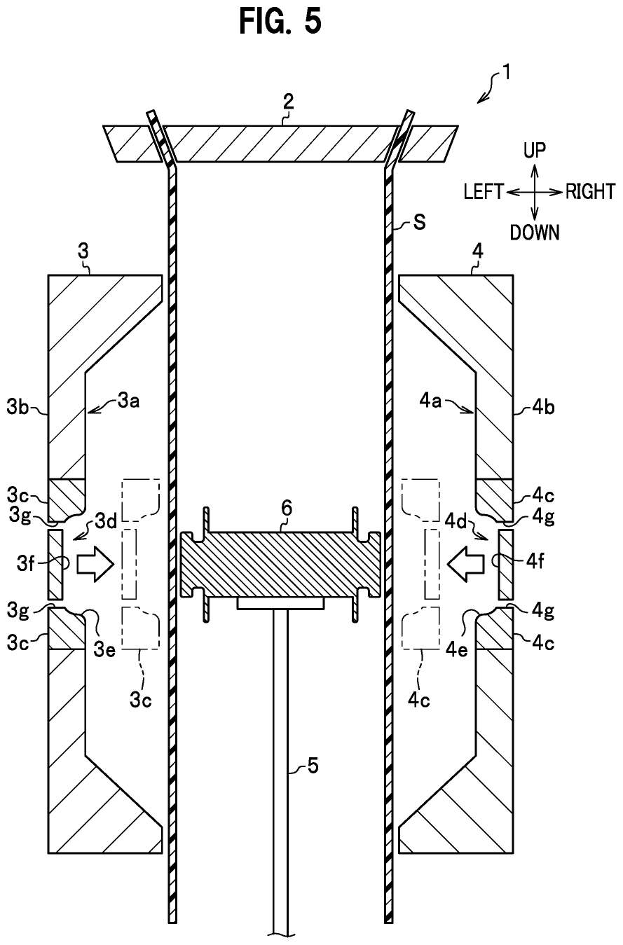

In reference to FIGS. 2 to 4, the configuration of the internal component 6 will be described. A parison S which is a precursor of the tank main body Ta (see FIG. 5) has a multilayered structure of made HDPE (high-density polyethylene), EVOH (ethylene-vinyl alcohol copolymer), adhesive layers, and the like.

As shown in FIG. 2, the internal component 6 includes a cylindrical torso portion 6a, shoulder portions 6b, 6b formed at both left and right ends of the torso portion 6a, neck portions 6c, 6c formed at the left and right outsides of the shoulder portions 6b, 6b, and head portions 6d, 6d. The structure of the internal component 6 is symmetrical in left and right (up and down on the paper). Therefore, unless explicitly stated, only one side will be described here. In the description of the internal component 6, the surface facing the torso portion 6a is referred to as the “back surface,” and the surface opposite to the “back surface” is referred to as the “front surface.”

The torso portion 6a shown in FIG. 2 is a part configured to be the main body of the internal component 6. Multiple hollowing holes may be formed in the torso portion 6a. These hollowing holes (not shown) are formed to reduce weight and improve moldability, as well as increase the capacity of the fuel tank T (see FIG. 1).

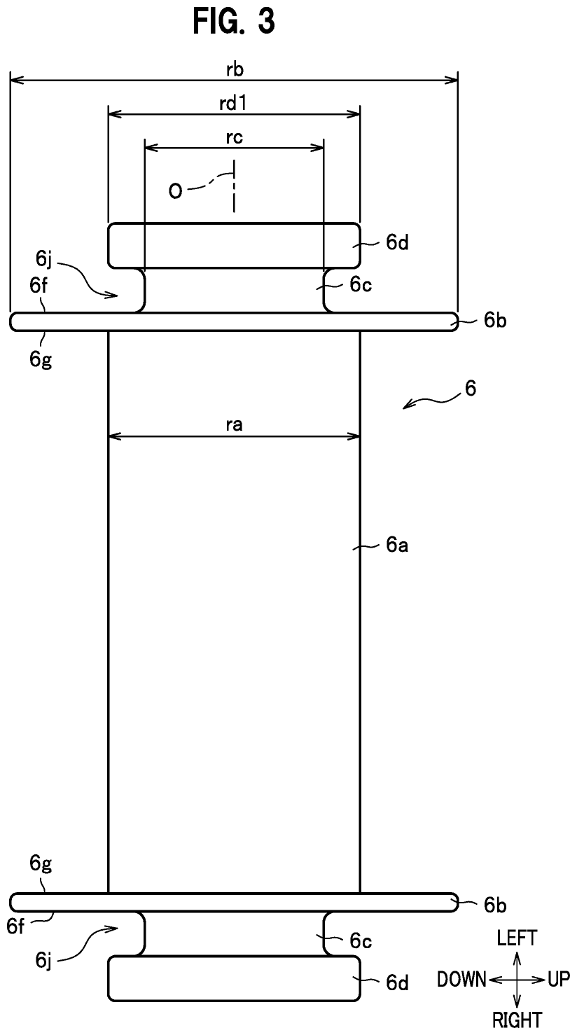

The shoulder portion 6b shown in FIG. 2 covers the recess 3d of the first mold 3 or the recess 4d of the second mold 4, shown in FIG. 5. The shape and size of the shoulder portion 6b are not particularly limited, as long as they can cover the recesses 3d, 4d. Here, the shoulder portion 6b has a thin circular plate shape, and as shown in FIG. 3, the outer diameter rb of the shoulder portion 6b is larger than the outer diameter ra of the torso portion 6a.

The neck portion 6c shown in FIG. 2 is a portion connecting the shoulder portion 6b and the head portion 6d, and as shown in FIG. 3, the neck portion 6c has a smaller diameter than the shoulder portion 6b and the head portion 6d. The neck portion 6c here stands from the surface 6f of the shoulder portion 6b and has a cylindrical shape. Rounded corners (radii) are formed in the corner portions formed by the shoulder portion 6b and the neck portion 6c, and in the corner portions formed by the head portion 6d and the neck portion 6c.

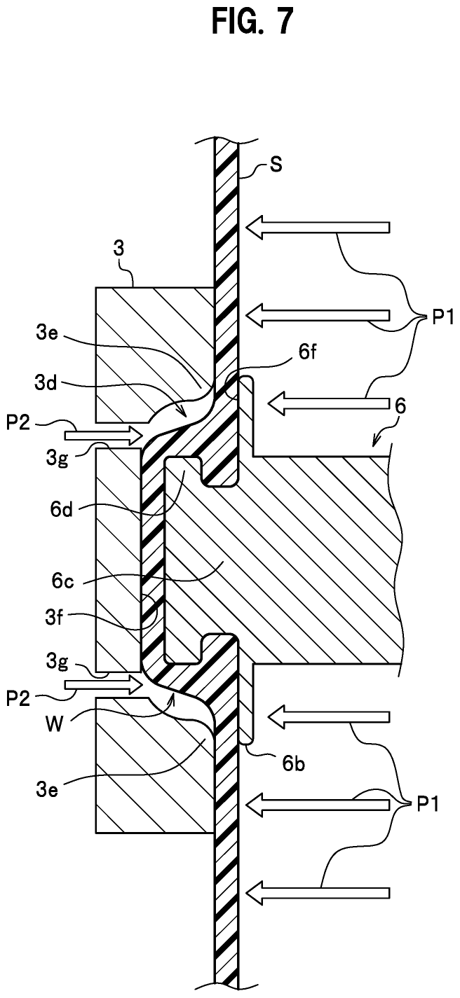

The head portion 6d shown in FIG. 2 has a shape of a thick circular plate, which is thicker than the shoulder portion 6b. However, the relationship in thickness between the shoulder portion 6b and the head portion 6d here is merely illustrative, and the shoulder portion 6b can also be formed thicker than the head portion 6d. As shown in FIG. 3, the outer diameter rd1 of the head portion 6d is larger than the outer diameter rc of the neck portion 6c and smaller than the outer diameter rb of the shoulder portion 6b. Due to this shape, a gap 6j is formed between the shoulder portion 6b and the head portion 6d, with the neck portion 6c as the bottom portion. The gap 6j is a portion where the parison S enters during molding. The part corresponding to the parison S wrapped around the neck portion 6c will be referred to as the “parison equivalent portion W” (see FIG. 7).

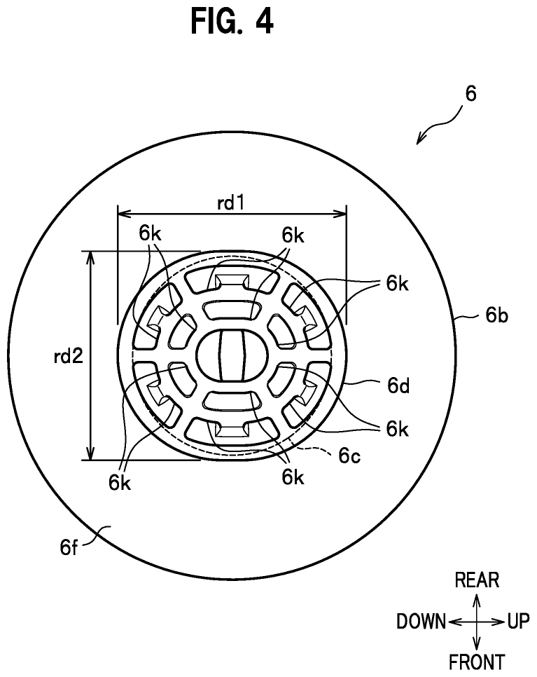

The shape of the head portion 6d has a rotation-stopping shape to prevent the internal component 6 from rotating along the circumferential direction of the head portion 6d. This rotation-stopping shape, as shown in FIG. 4, has an elliptical shape or substantially elliptical shape in the present embodiment. An outer diameter rd1 of the head portion 6d in the vertical direction is larger than an outer diameter rd2 of the head portion 6d in the horizontal direction.

The term rotation-stopping shape implies such a shape that after the internal component 6 is shaped onto the tank main body Ta, the internal component 6 will not rotate relative to the tank main body Ta. In the present embodiment, by making a difference in diameter between the outer diameter rd1 and the outer diameter rd2 of the head portion 6d, the rotation of the internal component 6 is restrained. The rotation-stopping shape can also be, for example, an oval shape. The oval shape includes, for instance, an elongated circle shape, a flattened circle shape, or a rectangle with rounded corners.

### <<Method for Manufacturing Fuel Tank According to Embodiment>>

The fuel tank manufacturing device 1 shown in FIG. 5 is a device that blow-molds a cylindrical parison S to produce a fuel tank T having an internal component 6 (see FIG. 1). Additionally, the fuel tank T can also be manufactured by molding a sheet-shaped parison (not shown).

As shown in FIG. 5, the fuel tank manufacturing device 1 mainly includes a die 2, a pair of first mold 3 and second mold 4, and an elevator 5 that moves up and down between the first mold 3 and the second mold 4.

The die 2 is located above the first mold 3 and second mold 4 and is a supply means for supplying the parison S to the first mold 3 and second mold 4. The parison S has a multilayered structure composed of HDPE (high-density polyethylene), EVOH (ethylene-vinyl alcohol copolymer), adhesive layers, and the like, and is a precursor of the tank main body Ta that constitutes the fuel tank T (see FIG. 1).

The first mold 3 and second mold 4 shown in FIG. 5 are molding means for compression-molding the fuel tank T (see FIG. 1). The first mold 3 and second mold 4 are arranged facing each other, and concave molding portions 3a, 4a are formed on their opposing surfaces. The first mold 3 and second mold 4 can open and close by moving in the left-right direction, and the parison S is supplied when the first mold 3 and the second mold 4 are in an open state (state as shown in FIG. 7). Also, the first mold 3 and second mold 4 include not-shown blow pins to send air into the first mold 3 and second mold 4, and the air pressure (blow pressure) inside the first mold 3 and second mold 4 is properly adjusted by a not-shown first positive pressure applying means. This first positive pressure applying means allows for transfer of the parison S to the molding portions 3a, 4a.

The first mold 3 is constructed to separate, and includes a main body portion 3b and a separable portion 3c that can be detached from the main body portion 3b. Similarly, the second mold 4 is constructed to separate, and includes a main body portion 4b and a separable portion 4c that can be detached from the main body portion 4b. The separable portions 3c, 4c are provided with recesses 3d, 4d formed therein, which correspond to the shapes of both ends of the internal component 6, and these recesses 3d, 4d accommodate a part of the internal component 6. The recesses 3d, 4d here have a cylindrical shape. Additionally, in the bottom portions 3f, 4f of the recesses 3d, 4d, multiple air holes 3g, 4g are formed to send air into the recesses 3d, 4d, respectively, and the air pressure (blow pressure) inside the recesses 3d, 4d is properly adjusted by a not-shown second positive pressure applying means.

The elevator 5 is a moving means for moving the internal component 6 to its installation position. The installation position here is inside the cylindrical parison S, and is between the separable portions 3c, 4c.

Next, the operation of the fuel tank manufacturing device 1 will be described. Before explaining the entire process of manufacturing the fuel tank T (see FIG. 1) by the fuel tank manufacturing device 1, the transfer status around the end portions of the internal component 6 will be described.

### <Transfer Status Around End Portions of Internal Component>

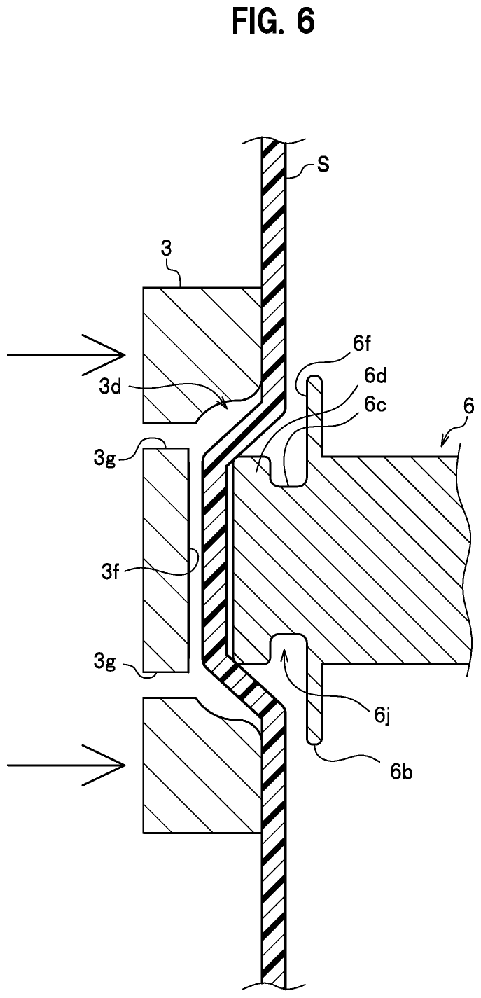

In reference to FIGS. 6 and 7 (and FIGS. 1 to 4 as appropriate), the transfer status of the parison S around the end portions of the internal component 6 during molding will be described. Note that here, the first mold 3 will be described because the second mold 4 is similar to the first mold 3. The internal component 6 shown in FIGS. 6 and 7 shows cross-sections cut at the A-A position in FIG. 2.

In the fuel tank manufacturing process, as shown in FIG. 6, by moving the first mold 3 in the arrow direction and clamping the parison S, the neck portion 6c and head portion 6d of the internal component 6 are pushed into the recess 3d together with the parison S.

As shown in FIG. 7, when the shoulder portion 6b contacts the parison S to cover the opening of the recess 3d, and the neck portion 6c and head portion 6d are completely pushed into (housed in) the recess 3d, a positive pressure P1 (first positive pressure) is generated inside the parison S by sending air into the first mold 3, transferring the parison S to the first mold 3. In addition, by sending air into the recess 3d through the air holes 3g formed in the recess 3d, a positive pressure P2 (second positive pressure) is generated inside the recess 3d to allow the parison S to enter the gap 6j between the shoulder portion 6b and the head portion 6d for transfer. The air in the gap 6j is discharged from the communication portions 6m formed in the neck portion 6c through the cutout portion 6k to the torso portion 6a.

Next, the overall process of the fuel tank manufacturing device 1 will be described.

### <Parison Injection Process>

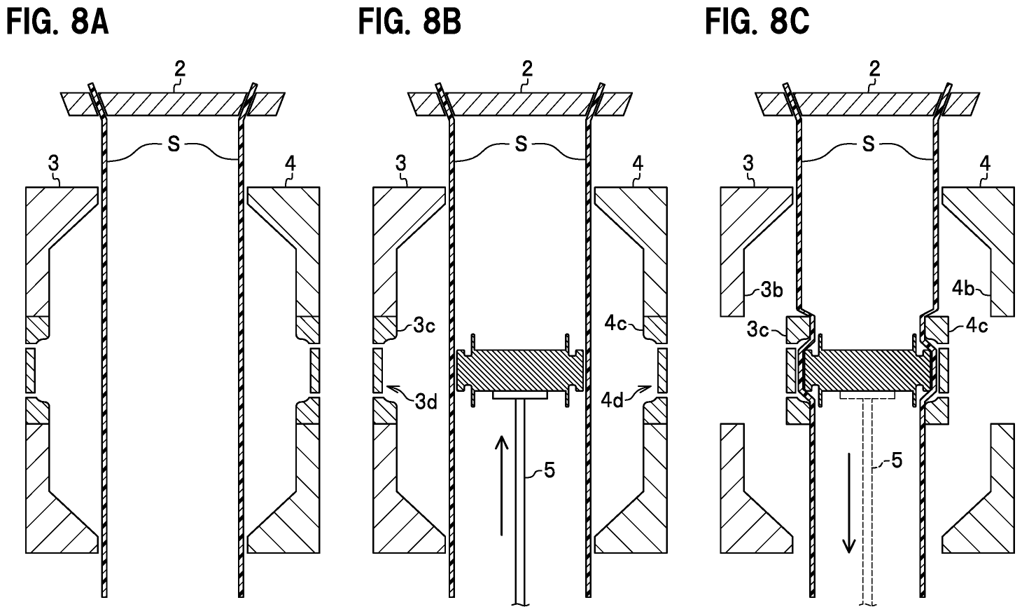

As shown in FIG. 8A, with the first mold 3 and second mold 4 opened, the die 2 injects a cylindrical parison S therebetween.

### <Internal Component Insertion Process>

Next, as shown in FIG. 8A, the elevator 5 rises with the internal component 6 held, and moves the internal component 6 to the attachment position. Here, the attachment position is inside the parison S and between the separable portions 3c, 4c.

### <Internal Component Temporary Setting Process>

Next, as shown in FIG. 8C, the separable portions 3c, 4c of the first mold 3 and second mold 4 move in directions facing each other to hold the internal component 6 by sandwiching the component 6 from both ends. Then, the elevator 5 descends with the internal component 6 released and retreats to the initial position. The initial position of the elevator 5 may be any position that does not interfere when the main body portions 3b, 4b of the first mold 3 and second mold 4 are closed.

### <Mold Closing Process>

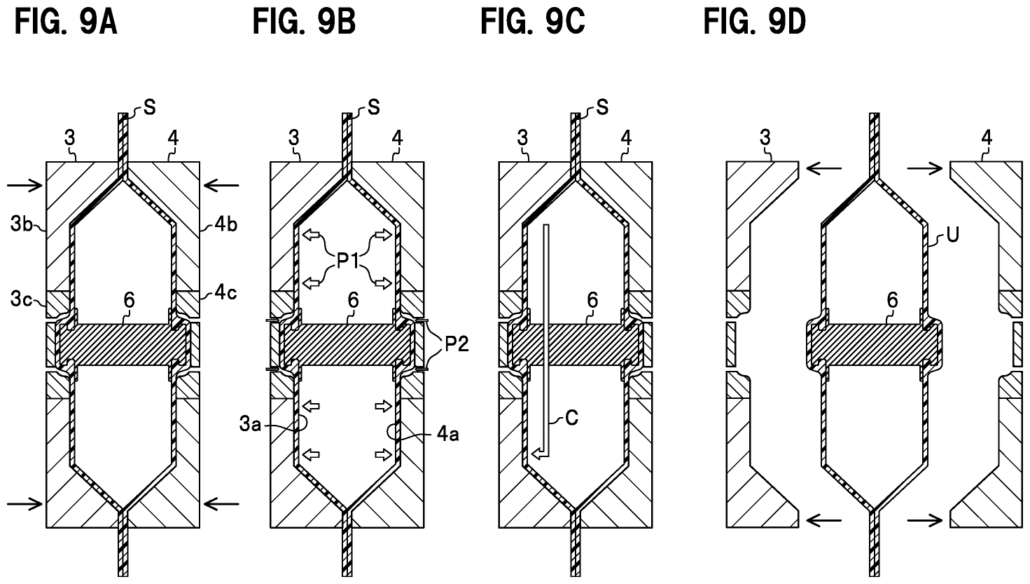

Next, as shown in FIG. 9A, the main body portions 3b, 4b of the first mold 3 and second mold 4 move in directions facing each other, and the first mold 3 and second mold 4 are clamped.

### <Blow Molding Process>

Next, as shown in FIG. 9B, the not-shown first positive pressure applying means applies a positive pressure P1 (first positive pressure) to the inside of the parison S in the first mold 3 and second mold 4. As a result, the parison S is pressed against and transferred to the molding portions 3a, 4a of the first mold 3 and second mold 4. Also, the not-shown second positive pressure applying means applies a positive pressure P2 (second positive pressure) to the outside of the parison S in the recesses 3d, 4d (see FIG. 7) of the first mold 3 and second mold 4. As a result, the parison S is shaped along the neck portion 6c of the internal component 6 (see FIG. 7). Note that there is no particular limitation on the method and order of applying the positive pressures P1 and P2. It is preferable that the positive pressure P2 is set higher than the positive pressure P1.

### <Parison Cooling Process>

Next, as shown in FIG. 9C, cooling air C is circulated inside the first mold 3 and second mold 4 using not-shown cooling means. As a result, the parison S is cooled and cured.

### <Mold Opening Process>

Next, as shown in FIG. 9D, the first mold 3 and second mold 4 are opened and the molded product U is taken out. Then, by cutting off unnecessary burrs formed at both ends, the fuel tank T (see FIG. 1) is completed.

According to the embodiment described above, the internal component 6 attached to the tank main body Ta includes a head portion 6d, a neck portion 6c, and a shoulder portion 6b, and the head portion 6d has a rotation-stopping shape to stop the rotation of the internal component 6. Therefore, compared to when the head portion 6d is circular, rotation of the internal component 6 can be made more difficult, suppressing rotation of the internal component 6 after parison molding.

Further, since the head portion 6d is an elliptical shape, it is easy to design and manufacture the rotation-stopping shape, and rotation of the internal component 6 can be suppressed simply and suitably. Note that in the present embodiment, the shoulder portion 6b and neck portion 6c are circular and the head portion 6d is elliptical or substantially elliptical. However, the shoulder portion 6b, neck portion 6c and head portion 6d may all be made elliptical or substantially elliptical so that they are similar. This improves the moldability of the internal component 6.

### Second Embodiment

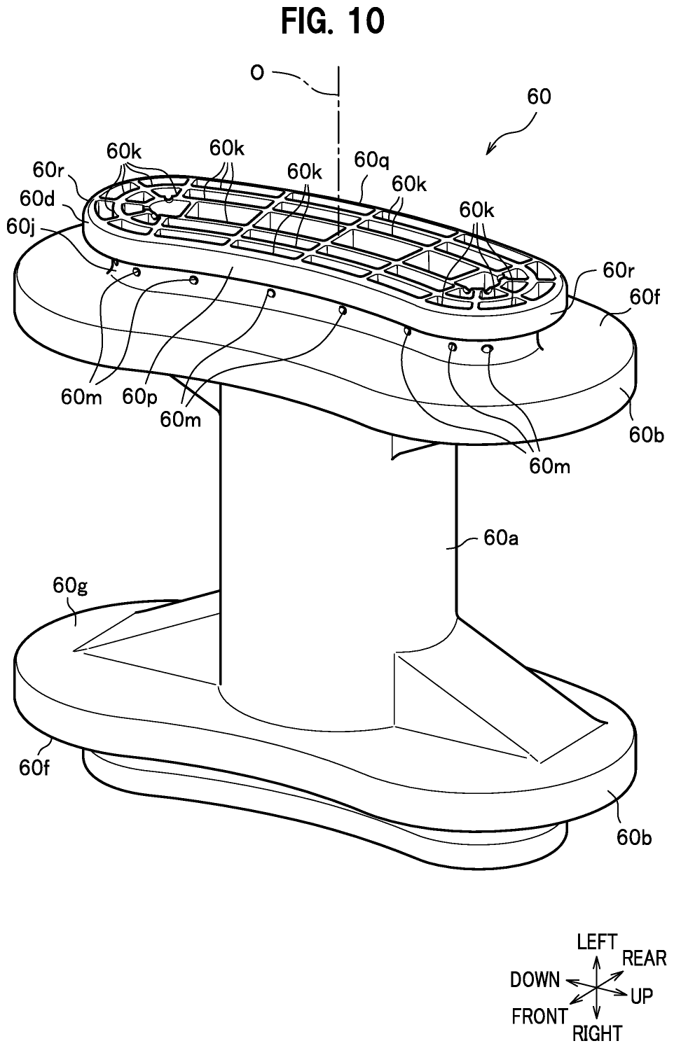

Next, an internal component 60 according to a second embodiment of the present invention will be described. As shown in FIG. 10, the internal component 60 includes a cylindrical torso portion 60a, shoulder portions 60b, 60b formed at both left and right ends of the torso portion 60a, neck portions 60c, 60c formed at the left and right outsides of the shoulder portions 60b, 60b, and head portions 60d, 60d. The structure of the internal component 60 is symmetrical in left and right (up and down on the paper).

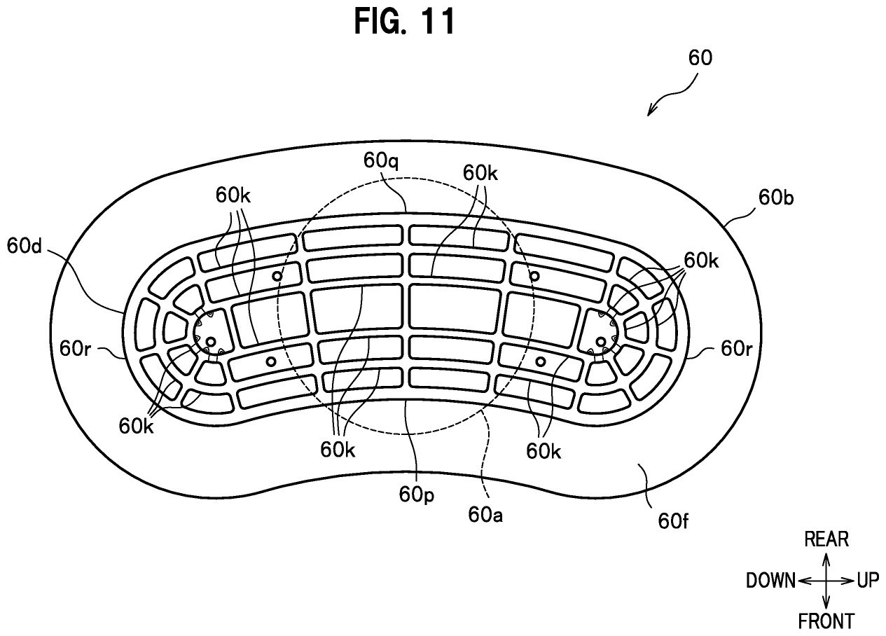

In the second embodiment, the rotation-stopping shape is such that the head portion 60d has a broad bean shape. Further, corresponding to the shape of the head portion 60d, the neck portion 60c and the shoulder portion 60b also have a broad bean shape, and these three portions are similar. As shown in FIG. 11, the head portion 60d includes an arcuate first opposing side 60p, an arcuate second opposing side 60q, a connecting piece 60r connecting one end side of the first opposing side 60p and second opposing side 60q, and a connecting piece 60r connecting the other end side of the first opposing side 60p and second opposing side 60q. The first opposing side 60p and second opposing side 60q are formed to be convex in the same direction (rear side). The connecting pieces 60r, 60r are formed to be convex in directions away from each other.

As shown in FIG. 11, multiple cutout portions 60k are formed in the head portion 60d and neck portion 60c. The cutout portions 60k open at the end surface of the head portion 60d and are hollow from the head portion 60d to the neck portion 60c. As in the second embodiment, the rotation-stopping shape of the head portion 60d may be a broad bean shape. The other configurations and effects of the second embodiment are the same as those of the first embodiment, and thus description thereof is omitted.

The embodiments of the invention have been described, but design changes are possible within the scope not departing from the gist of the present invention. Although the parison was made to wrap around the neck portion by positive pressure from outside the parison (blow molding) to fix the internal component, other molding methods may be used for molding.

### REFERENCE SIGNS LIST

6, 60 internal component
6a torso portion
6b shoulder portion
6c neck portion
6d head portion
S parison
T fuel tank
Ta tank main body

1. A fuel tank comprising an internal component including a head portion, a neck portion and a shoulder portion, the internal component being fixed on a tank main body by shaping a parison to the head portion, the neck portion and the shoulder portion during molding of the tank main body, wherein
the head portion, the neck portion and the shoulder portion are respectively formed at both ends of a columnar torso portion, and the shoulder portion is formed larger than the head portion and the neck portion,
the head portion and the neck portion are embedded in opposing internal surfaces of the tank main body by wrapping the parison around the neck portion during molding of the tank main body, and
the head portion has a rotation-stopping shape.

2. The fuel tank according to claim 1, wherein the rotation-stopping shape is an elliptical shape or an oval shape.

3. The fuel tank according to claim 1, wherein
the head portion, the neck portion and the shoulder portion are similar, and
the rotation-stopping shape is a broad bean shape.
